(19) United States
(12) Patent Application Publication
(10) Pub. No.: US 2015/0032234 A1
(43) Pub. Date: Jan. 29, 2015

(54) SYSTEM FOR TRADING PLAYER UNITS ASSOCIATED WITH A PORTFOLIO OF PLAYER UNITS

(71) Applicant: Mitchell Winston Bihuniak, Cleveland, OH (US)

(72) Inventor: Mitchell Winston Bihuniak, Cleveland, OH (US)

(21) Appl. No.: 13/950,944

(22) Filed: Jul. 25, 2013

(51) Int. Cl. A63F 13/828

(52) U.S. Cl. CPC A63F 13/828
USPC 700/91

(57) ABSTRACT

Systems and methods for trading player units of a portfolio of player units are described herein based in part on granting a user access to a user account based on registration data associated with the user whereby the registration data corresponds to at least one registration guideline in accordance with a league comprising one or more user. In an aspect, the user is enabled to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price;

### CROSS REFERENCE TO RELATED APPLICATIONS

The subject patent application claims priority to U.S. Provisional Patent Application Ser. No. 61/665,074, filed on Jul. 25, 2012, entitled “Systems for Competitive User Game Play”, which is incorporated herein by reference in its entirety.

### TECHNICAL FIELD

This disclosure relates to a system for trading one or more player units of a portfolio of player units whereby each player unit corresponds to a value.

### BACKGROUND

Generally, a fantasy sport game comprises a group of users each of whom act as an owner of a user-built team comprising virtual players. The virtual players accumulate points for the user-built team based on real life player statistics associated with each individual athlete performance in a real world athletic competition. The owners of each user-built team compete against other user-built teams to see whom can assemble a team of virtual players that score the most points (as a function of real world athlete statistics). Often, fantasy sport games are limited in that such games do not grant a user the opportunity to perform realtime changes to a user-built team within a league upon commencement of a competition. For instance, a user cannot make athlete player lineup changes to a user-built team upon commencement of a real world athletic competition (e.g. after the beginning of weekly football matches, such as Thursday at 8:30 p.m. each week).

Not only to fantasy sport games lack dynamic game-play functionality but they also lack a means for valuing individual players in realtime and allowing for the incorporation of realtime player value variances into fantasy game-play. For instance, a user is locked into game-play each week after establishing a lineup, which inhibits a user from benefitting from real-time game scenarios that could benefit its user-built team. Furthermore, users currently are unable to capitalize on the value fluctuations of individual players during gameplay as well. These limitations and other such issues are associated with current fantasy sport games and limit the user experience when participating in such games.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with systems and methods for trading one or more player units of a portfolio of player units whereby each player unit corresponds to a fair market value. In accordance with a non-limiting embodiment, in an aspect, a system is provided comprising a memory having stored thereon computer executable components, and a processor, communicatively coupled to the memory, that executes or facilitates execution of one or more computer-executable components, the computer-executable components, comprising: registration component that grants a user access to a user account based on registration data associated with the user whereby the registration data corresponds to at least one registration guideline in accordance with a league comprising one or more user; an assignment component that assigns at least one virtual currency unit to the user account based on a predefined rule or the at least one registration guideline; a drafting component that enables the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price; a selling component that enables the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price; a scoring component that assigns a score to a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account; and a ranking component that ranks the user account associated with a respective user based on the scoring.

The disclosure further discloses a method, comprising using processor to execute computer executable instructions stored in a memory to perform the following acts: granting a user access to a user account based on registration data associated with the user whereby the registration data corresponds to at least one registration guideline in accordance with a league comprising one or more user; assigning at least one virtual currency unit to the user account based on a predefined rule or the at least one registration guideline; enabling the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price; enabling the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price; assigning a score to a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account; ranking the user account associated with a respective user based on the scoring.

The following description and annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in condunction with the drawings.

### BRIEF DESCRIPTION OF THE DRAWINGS

FIG. 1 illustrates an example non-limiting system for trading player units associated with a portfolio of player units.

FIG. 2 illustrates an example non-limiting system for trading player units including a payment component.

FIG. 3 illustrates an example non-limiting system for trading player units including a customization component.

FIG. 4 illustrates an example non-limiting system for trading player units including a demand component.

FIG. 5 illustrates an example non-limiting system for trading player units including a locking component.

FIG. 6A illustrates an example non-limiting system for trading player units including a classification component.

FIG. 6B illustrates an example non-limiting system for trading player units including a classification component.

FIG. 7A illustrates an example non-limiting display of a user interface for drafting player units.

FIG. 7B illustrates an example non-limiting display of a locked portfolio window.

FIG. 7C illustrates an example non-limiting display of user interfaces during gameplay.

FIG. 7D illustrates an example non-limiting display of user interfaces during gameplay.

FIG. 8 illustrates an example methodology for registering, enabling purchasing, enabling selling, ranking, caching and transmitting media content sections.

FIG. 9 is a block diagram representing an exemplary non-limiting networked environment in which various embodiments can be implemented.

FIG. 10 is a block diagram representing an exemplary non-limiting computing system or operating environment in which various embodiments may be implemented.

### DETAILED DESCRIPTION

### Overview

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

By way of introduction, the subject matter disclosed in this disclosure relates to a system for trading player units representing an athlete competing in athletic competitions. To facilitate a unique moment to moment fantasy gaming competition for user participation a system and various non-limiting embodiments is disclosed that allows a user to create a portfolio of player units, each of which is associated with a valuation that can be based on various factors such as real-time athlete statistics (e.g passing yards, touchdowns, interceptions, fumbles, rushing yards, three point baskets, soccer goals, etc.) associated with a respective player unit, the demand by other users for such player unit, historical performance data, and so on. Together, the various factors taken into consideration as an alogrithm comprise a value assigned to each player unit whereby users can purchase and sell to or from the market or other users each player unit for a quantity of virtual unit. Each user competes against other users by valuing each users respective portfolio comprising a set of player units as compared to other users portfolio value.

The disclosure provides a system that allows a user to buy player units from other users or a common market or sell player units to other users or a common market during the course of gameplay. This user empowerment allows for a greater level of interaction and control over the result of a respective user team performance. This level of competition also requires a different strategic plan for users whereby any realtime event in a sport competition could contribute to a fluctuation in the value of one or more player unit. Furthermore, there are a variety of application features that contribute to the competitiveness of any single game such as: free or paid-for leauges, realtime buying, realtime selling, single or multiple games, total portfolio value competitions, one-on-one user games, competitions with multiple users, knockout competitions, immediate payout to winner competitions, blue chip bonuses for top positional performers, ticker symbols associated with player units, player unit profiles, player unit rankings, buy and sell analysis, user titles, user rankings.

In an instance, a game can comprise one or more users whereby each user is allotted a virtual currency balance to purchase player units. For example, a competition can comprise four users: user A, user B, user C, and user D. If the game is related to a football competition then each user purchases at least one player unit for a number of mandatory positions (e.g. quarterback, runningback, tight end, defense, kicker). There is no order for purchasing player units and each user can purchase the same player unit. For example, user A can purchase the player unit representing Tom Brady at the quarterback position and user D can also purchase the player unit representing Tom Brady as quarterback. In an aspect, whereby more than one user purchases the same player unit, the system can incorporate a custom demand feature that assigns a higher purchase price to the user whom purchased Tom Brady second thereby imputing a greater value to the player unit representing Tom Brady, in part, due to, the increasing demand for the player unit representing Tom Brady.

In an aspect, each user holds a portfolio comprising purchased player units with an associated value. Upon the purchase of a player unit from each mandatory position by all users in a competition, the game commences and each user can purchase and sell player units to and from one another or the market. At the finish of a stated period of time (e.g. the league administrator or creator can assign a time period for game play such as four hours, one day, one week, or one month, etc.) each users total portfolio value is calculated (e.g. the summation of the value of each individual player units comprising a respective user portfolio) based on any one or more variables (e.g. assigning multiples or bonus value for various statitics or user related actions, or trades). The user holding the highest total portfolio value is declared the winner of a competition. This non-limiting example of a gameplay generally demonstrates the manner by which the disclosed system can be implemented.

Example System for Trading Player Units Associated with a Portfolio of Player Units

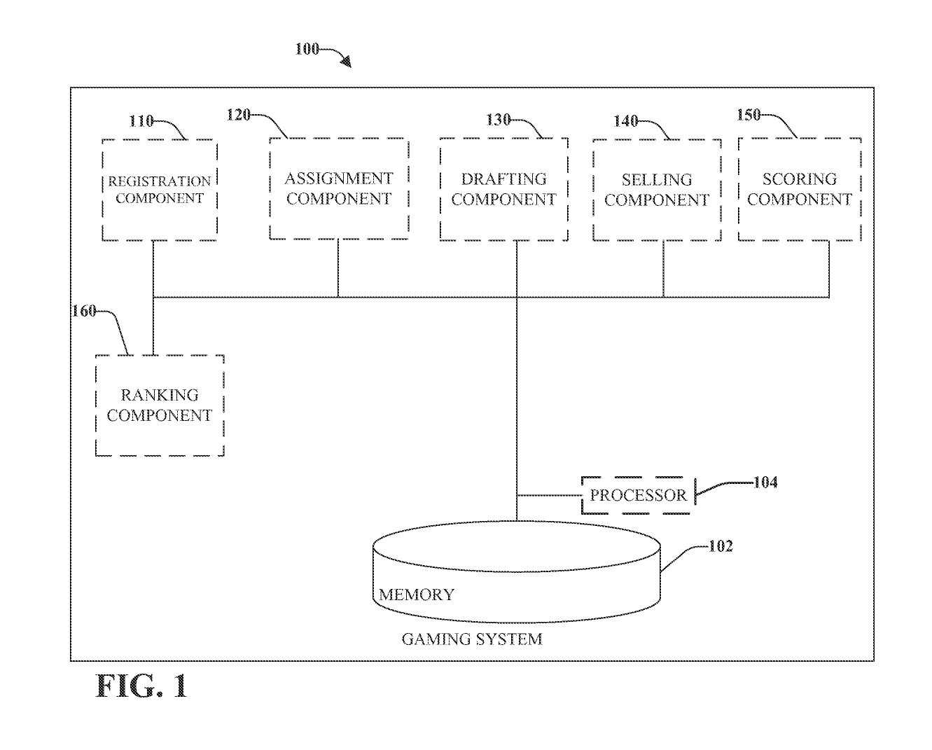

Referring now to the drawings, with reference initially to FIG. 1, system 100 is shown that facilitates trading one or more player unit associated with a portfolio of player units. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 102 for storing computer executable components and instructions. A processor 104 can facilitate operation of the computer executable components and instructions by the system 100.

In an embodiment, system 100 employs a registration component 110, assignment component 120, drafting component 130, selling component 140, scoring component 150, ranking component 160. A registration component 110 grants a user access to a user account based on registration data associated with the user whereby the registration data corresponds to at least one registration guideline in accordance with a league comprising one or more user. An assignment component 120 assigns at least one virtual currency unit to the user account based on a predefined rule or the at least one registration guideline. A drafting component 130 enables the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price. A selling component 140 enables the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price. A scoring component 150 assigns a score to a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account. A ranking component 160 rank the user account associated with a respective user based on the scoring.

In an embodiment, registration component 110 grants a user access to a user account based on registration data associated with the user whereby the registration data corresponds to at least one registration guideline in accordance with a league comprising one or more user. System 100 can be implemented at a device by using a program or website to facilitate a user registration (e.g. via registration component 110) to gain access to the system. In an aspect, registration component 110 can grant a user access to a user account based on registration data associated with the user. A user is any consumer of system content such as a person (e.g. sport enthusiast, members of a social circle, etc.), entity, organization, or any individual in general. A user registers (e.g. using registration component 110) with the system to create a user account. In an aspect, a user account is a subset of data based on registration data stored at a data store whereby the registration data can comprise data that represents at least one registration guideline.

In an aspect, a registration guideline is a course of action that defines one or more action, routine, practice or rule that defines each competition of system 100. For instance a registration guideline can establish competition parameters such as the date or range of dates a competition is to be performed, the price to participate in a competition or to join a league for each user, the time frame within which the occurrence of the competition will take place, the type of sport to be represented by the competition (e.g. American football, soccer, rugby, basketball, hockey, cricket, baseball, polo, etc.), the price to be incurred as relates to a particular transaction (e.g. selling a player unit, purchasing a player unit, gaining access to add-on features, monitoring statistics via a player unit ticker, etc.), the virtual currency amount allotted to each user of a league, and other such guidelines to facilitate the parameters of each competition.

In an aspect, the registration data is related to a user account in that a user account corresponds to a subset of registration data. For instance, the subset of registration data can comprise user information such as an account user name, an account password, and other such credentials specific to a particular user (e.g. address, payment information. The user account can also comprise a subset of information related to a specific user portfolio of player units or competition specific information (e.g. portfolio's of player units for various sport competitions, historical record of user performance, awards provided to the user, etc.). A user can access a user account subsequent to account creation by providing (e.g. via registration component) unique credentials specific the user to prove the user identity (e.g. username, password). Upon successful proof of identification, the user can access its respective user account time after time.

In an aspect, the registration component 110 can grant a user access to system 100 whereby the access includes access to features such as a website, portfolio manager application, applications to connect with other users (e.g. via e-mail, instant messaging application, etc.), access to a social network, access to social media and other such applications. The access can include a user ability to view a website employed by the system 100, demonstrations illustrating the way to use the site, sample portfolio's, tutorials and competition instructions for user help. Additionally, in an aspect, the predetermined rule or registration guideline can include data related to the league functionality. In an aspect, a user or the administrator of the system 100 can customize a league by setting registration guidelines such as the day or time to draft player units for each user team, the sport genre (e.g. football, soccer, hockey, etc.) representative of the league, transaction limits (e.g. the number of free transactions per user), established league payment dues, virtual currency allotment, invitation settings for other users to join the league (e.g. via e-mail, text, social media tools, etc.)

In another aspect, registration component 110 can grant a user access to a league comprising one or more users. A league is a group of one or more users engaging in competition against one another. For instance, a league can comprise user A, user B, user C, and user D whereby each user purchases one or more player units to collectively form a portfolio of player units. Each player unit is associated with a value and the users compete against one another by a scoring mechanism that takes into account the value of each user portfolio. As an example, user C can register (e.g. via registration component 110) to system 100 and create a user account. Furthermore, user C can access the user account and gain access to a league comprising user A, user B, user C, and user D. Accordingly, user C can access personal account information (e.g. payment information, proposed trades, messages from other users, etc.) and league information (e.g. portfolio values of other users, matchups, current rankings of each user, etc.).

In another aspect, the registered users can participate in more than one league, whereby the league can be a public league (e.g. any member of the public can become registered user of the league) or a private league (e.g. an invitation by a user that created the league is required to gain access to the league). There can also be custom competitions available to registered users for setup outside of the league format (e.g. head-to-head competitions, bracket competitions, parlayed competitions, multiple sport genre competitions, portfolio profiles comprised of player units from multiple sports, etc.). Furthermore, a user can customize a user account or a league (e.g. a user that creates a league) to access private registration data (e.g. displayed personalized data, private messaging network, etc.), private personalized settings (e.g. pictures, logos, user account name, league name, etc.), control features (e.g. disable spam), communicate with other users (e.g. convey updates to the league or user account, announce events or changes, etc.). Also, in an aspect, the user account enables a user to perform actions related to the user account or league from the respective users registered identity (e.g. e-mail, change requests, etc.).

In another non-limiting, system 100 employs an assignment component 120 that assigns at least one virtual currency unit to the user account based on a predefined rule or the at least one registration guideline. In an aspect, assignment component 120 in connection with registration component 110 can assign user a virtual currency unit amount to a user. A virtual currency unit is a digital unit of currency in a virtual economy that allows a user to perform various transactions and expend value that is not directly real money. In an aspect, the virtual currency can be purchased with real money in order to participate in a league. For instance, user A, user B, user C, and user D can access a league created by user C. User C can establish a registration guideline (e.g. via registration component 110) to require a payment of ten US dollars ($10.00) to enter the league. User C can establish other guidelines as well, but user C can establish a guideline that upon payment of ten US dollars (e.g. through a payment portal, e-commerce account, payment account or other mode of payment associated with system 100), each user is allotted a virtual currency amount, such as one hundred virtual currency units.

Each user can use the virtual currency units to perform actions related to the league competition such as purchasing player units, purchasing merchandise, purchasing additional features (e.g. ticker, additional statistical tracking feature, etc.). Thus, in an aspect a user can purchase an established amount (e.g. established by the league creator, automatically established by a system administrator, etc.) of virtual currency units to perform acts related to the competition. Additionally, in an aspect, a pre-defined rule is an established rule not set by a creator but rather established by a system administrator, such as whether a free-league is available to users, a transaction amount to administer per purchase or sale of a player unit, the correlation between statistical performance of athletes and the value of a player unit, the weight of various variables or constants that contribute to a valuation, and so on.

In another non-limiting, system 100 employs a drafting component 130 that enables the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price. In an aspect, drafting component 130 enables the user to purchase a player unit. A player unit is a representation of an athlete associated with a sporting event. For instance, a player unit can represent Tom Brady, a football athlete belonging to the New England Patriot team whom performs the role of a quarterback. The user of a league can purchase the player unit associated with Tom Brady using one or more virtual currency unit.

In an aspect, a user can spend up to the allotment of virtual currency units to purchase player units. In another aspect, a feature can be enabled to allow for additional virtual currency units to be paid for by a user and thereby increase the virtual purchasing power of the user. Thus, if user whom established a registration guideline for a league establishing a virtual currency unit (e.g. virtual dollars) allotment of seven hundred fifty virtual dollars, then each user can spend a maximum of seven hundred fifty virtual dollars to purchase all player units belonging to a portfolio. In another instance, the user creating a league can establish a registration guideline that allows flexible purchasing of virtual currency units to increase the purchasing power of each user at the respective users discretion.

Also, in an aspect, the purchase price can be based on at least one of: a market rate, a bid price, a demand price, athlete statistical performance or a custom price. The purchase price of a player unit is representative of the value of the player unit according to various variables, constants, weighting and statistical evaluations associated with the competition. In an aspect, the purchase price can be based on a market rate which is a rate established by a common market valuation. For instance, at the commencement of portfolio creation by a user (e.g. during the initial draft of player units), the valuation of a player unit can be based on a market rate in accordance with a valuation algorithm that considers various factors.

In an instance, a user seeking to purchase a Tom Brady player unit can pay a purchase price of an amount of virtual currency units based on the statistical performance of the athlete the player unit represents such as the quarterback rating, pass completions, throwing attempts, percentage of completions to attempts, aggregate yards completed, touchdowns achieved, interceptions thrown, average yards per game, rushing yards, yards per attempt, number of sacks, number of fumbles, and other such statistics. Each respective athlete belonging to a particular sport can be valued (e.g. by drafting component 130) based on statistics relevant to that particular sport or the particular position (e.g. forward, point guard, running back, defender, goalie, etc.) or role the athlete fulfills. In yet another aspect, the valuation of a player unit can be based on a user valuation, whereby the user can offer a player unit for a particular virtual currency amount and thus another user can purchase the player unit for such price.

Furthermore, in an aspect a valuation of a player unit can be in accordance with a bid price whereby each user can put out a bid price, which is amount the respective user is willing to pay in virtual currency units for that player unit. The bid price can be controlled by the user performing the bid itself or an administrator (e.g. system 100 operator, league creator, etc.) can act as an intermediary to facilitate the bidding process. Accordingly, the ask price can be an offering price in association with a player unit that a user can request during a sale. The bid for a player unit can be unsolicited whereby a user receives a bid to purchase a player unit for a particular bid price despite a user not offering the player unit for sale. Also, the bid for a player unit can be solicited whereby a user bids for a player unit in accordance with an ask price requested by the user interested in selling the player unit.

In an aspect, drafting component 130 can enable more than one user to purchase the same player unit. Thus, a user A and a user B of a league can both own a player unit representing LeBron James. The valuation in such a scenario can be based in part on a demand price such that the increased user demand for a player unit can contribute to the price of the player unit in some capacity. For instance, user A can purchase the player unit representing athlete LeBron James for one hundred virtual currency units, subsequently, user B can purchase LeBron James for greater than one hundred virtual currency units (e.g. one hundred twenty virtual currency units) based in part on the nature of increased demand for the player unit. In the example, user A is rewarded for purchasing the player unit before user B. Furthermore, the contributing value to total portfolio value of the player unit is greater for user A than user B. In another instance, the valuation can be based on demand and supply economics whereby a limited supply of each player unit is available for purchase thereby influencing the purchase price for the player unit accounting for supply constraints. Thus for instance, in a league comprising six users, an allotment of two player units representing each athlete can be available (e.g. pursuant to a registration guideline or predetermined rule).

Regarding valuation methodologies, system 100, in an aspect, can integrate more than one valuation type (e.g. via drafting component 130) in coordination with one another. For instance, a demand price value and a market price value can be used together, separately, or in reference to one category of player unit but not with a category of player unit. In an aspect, the value of a player unit can be based on statistical performance of an athlete as described above but also as a function of a custom price. A custom price can take into consideration other means of valuation such as league statistics whereby the data associated with the activities of public users or private users can contribute to the valuation of respective player units. For example, a standard deviation, average, median, confidence interval, or other statistical analysis of user activities across all leagues and the system 100 can contribute to the price of player units as well.

If a user does not utilize all virtual currency units to purchase player units comprising the portfolio, then the value of the residual unspent virtual currency contributes to the total portfolio value. The portfolio can be a compilation of player units in various capacities. For instance, a football based league of system 100 may require each user to select one player unit matching each position of a defined set of available positions. Thus a football-based league can require a user to purchase one quarterback, running back, tight end, defense, and kicker as part of the player portfolio. In another instance, a basketball league can require a user to purchase a point guard, power forward, center, shooting guard, and small forward. Each user of a league can choose to purchase any player unit belonging to each respective position category to contribute to the total portfolio.

In an aspect, the position categories can be customized for each league depending on the league creator or a system administrator's preference (e.g. flex positions, all quarterback positions, a position from basketball and baseball, etc.). At the time of the initial league draft whereby the users are purchasing player units for the first time prior to competition, each user will lock the portfolio (e.g. finalize the portfolio selections to represent the users team at the start of the competition). After the competition commences based on a registration guideline or predefined rule (e.g. the start of football season, the commencement of a basketball tournament, the beginning of a soccer match, etc.) each user can purchase (e.g. using drafting component) and sell player units (e.g. using selling component) discretionarily.

In another non-limiting, system 100 employs a selling component 140 that enables the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price. In an aspect, as compared to drafting component 130, selling component enables a user to sell a player unit representing an athlete to the market or another user. In an aspect, the acts of buying and selling player units has a significant impact on the league competition in that the scoring and ranking of users are based on valuations (e.g. increasing the valuation of the portfolio as much as possible, marginal increase of portfolio value, etc.).

Thus, in an aspect, a user can sell a player unit (e.g. by using selling component 140) at a market rate, or a price based on an athlete statistical performance, a custom price or an ask price. The valuations can be determined using the same valuation mechanisms described herein. Thus, if a player unit representing Peyton Manning at the quarter back position receives an injury during the season the value of the player could decrease as a result of forecasted factors such as inhibition of performance due to physical limitations or absence from a game. Conversely, if the player unit representing Peyton Manning throws five touchdowns and four hundred passing yards in the previous week game, then the valuation can go up due to increased statistical performance, forecasted performance outlook, and other such factors. In another aspect, the selling component 140

In another aspect, the sale price can be based on an ask price which is the price the user selling the player unit requests for the player unit. The selling user can provide a firm asking price whereby the seller user will not change the price requested for the player unit. In another aspect, the seller user can request a negotiable ask price whereby the seller user can entertain attempts by the buying user to change the offering price for the player unit. The ask price and bid price for player units can be established by an administrator of the system 100, a user creator of a league, the users of league themselves, or automated pursuant to predetermined rules. In an aspect, a user can perform as many transactions as desired in accordance with transaction limits (e.g. as a function of a predetermine rule or registration guideline). In an instance, a free allotment of transactions can be provided to users and each additional transaction can require a payment of virtual currency or real money (e.g. US Dollar amount).

As an example of how the valuation can be affected by a purchase or sale of player units, the scenario whereby user A purchases a player unit representing Tom Brady for one hundred (100) virtual currency units (e.g. virtual dollars for illustration of the example) at the commencement of the initial draft and the Tom Brady player unit currently is valued at one hundred fifty (150) virtual dollars illustrates the concept of portfolio value. User A is also watching a football game matchup of the Cleveland Browns versus the Washington Redskins whereby the Cleveland Browns are situated at the two yard line of the opponent while maintaining possession of the football. User A notices the player unit representing Trent Richardson, the Cleveland Browns running back, is valued at eighty five (85) virtual dollars and user A believes Trent Richardson will run to a touchdown and score points for the Cleveland Browns. User A sells the player unit representing Tom Brady (e.g. to the public market) for one hundred fifty (150) virtual dollars and purchases the player unit representing Trent Richardson for eighty five (85) virtual dollars at the commencement of the game and after Trent Richardson scores the touchdown, his player unit increases in value to one hundred (100) virtual dollars. User A realized a profit of sixty five (65) currency units comprising the inflow of one hundred fifty (150) virtual dollars from the sale of the Tom Brady player unit and the outflow of eight five (85) virtual dollars from the purchase of Trent Richardson player unit whereby the difference is sixty five virtual dollars. Additionally, because the Trent Richardson player unit is now increased in value from eighty five (85) to one hundred (100) virtual dollars, the total portfolio value of user A also increases by the fifteen (15) virtual dollars as well (e.g. this can be captured as an unrealized gain or a realized gain depending on the registration guidelines or predetermined rules).

In another aspect, with respect to each transaction incurred by a user, the virtual currency balance associated with each respective user is monitored via a user account and corresponding user data. A user account can tabulate and track debited and credited amounts associated with virtual currency inflow and outflows associated with a user activity. In an aspect, a user can select a player unit (e.g. by purchasing or selling the player unit) in a variety of formats such as dragging and dropping player units, choosing from a table or list format of player units, check marking player units for selection and other such selection formats.

In another non-limiting embodiment, system 100 employs a scoring component 150 that assigns a score to a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account. In an aspect, system 100 facilitates a competition among users and as such scoring the performance of each user serves as a metric for determining user performance. In an aspect, the scoring component 150 assigns a score to a user portfolio as a function of total portfolio value. The total portfolio value is the aggregate sum of the values of each player unit within a user portfolio and unspent virtual currency unit balances associated with a user account at the end date of a competition.

For example, at the closing date of a competition, user A owns three player unit each valued at fifty, twenty, and one hundred twenty virtual currency units respectively. Also, user A has fifty unspent virtual currency units so collectively the total portfolio value of user A is two hundred forty (50+20+120+50=240). In an aspect, scoring component 150 can score a user based on the total portfolio value, which in this case is 240 thus a score of 240 can be assigned to user A. In yet another aspect, scoring component 150 can contribute other scoring variables to assign a score to a user. For example, a score can be assigned to a user based on strategic transactions incurred, greatest or least margin of gain of a player unit value, most transactions incurred, greatest portfolio increase during a range of time, and other such scoring variables.

Additionally, in an aspect, a score can be based on a total portfolio gain whereby a score is assigned to a user based on the magnitude of difference between the total portfolio value at the completion date of a competition and total portfolio value at the commencement date of a competition. For instance if user A began a competition with a total portfolio value of one hundred (100) virtual currency units and at completion of the competition the total portfolio value is three hundred (300) virtual currency units the portfolio gain is two hundred (200) virtual currency units. Thus, a user A portfolio gain of two hundred (200) virtual currency units may be assigned a score (e.g. via scoring component 150) greater than the score assigned to user B of a one hundred (100) virtual currency units total portfolio gain.

Similarly, the scoring can be based on a total portfolio loss as well. In another aspect, the scoring can be based on a total percentage gain or a total percentage loss corresponding to a respective user account. Thus in the above example, despite user A performing a two hundred percent (200%) gain in portfolio value ([(300-100)/100]), user B could be assigned a greater score even with less of a total portfolio value in that wherein the commencement date of competition portfolio value was ten (10) virtual currency units and the completion date total virtual currency value was one hundred ten (110) the total percentage gain is one thousand percent ([(110−10)/10]). In an aspect, the scoring can be related to time frames whereby total portfolio is captured. For instance, during the weeks wherein playoffs of sporting events occur, the scoring scale can be weighted differently than during regular season time periods. The scoring can take into consideration weighting, averaging, and performing other statistical analysis with respect to the portfolio values.

In another non-limiting embodiment, system 100 employs a ranking component 160 that ranks the user account associated with a respective user based on the scoring. In an aspect, the competition is completed and the users are assigned ranks. In an aspect, ranking component 130 ranks a user based on the scoring. For instance, whereby a competition is within a league comprising eight users, the highest ranked three users can be deemed winners and awarded a reward based on the rank respectively. In a case whereby the scoring was based on total portfolio value, and user A scores one hundred fifty (150), user B scores one hundred thirty (130), and user C scores one hundred ten (110), then the whereby the ranking occurs from highest score to lowest score; user A obtains first place, user B obtains second place, and user C obtains third place as ranked by ranking component 160.

Accordingly, each user can be paid a reward, for example a payment of $65.00 US Dollars to user A (e.g. first place rank), $15.00 US Dollars to user B (e.g. second place rank), and $10.00 US Dollars to user C (e.g. third place rank). In an aspect, the administrators of system 100 can earn a transaction fee (e.g. a percentage of the total buy-in amount). The earnings are related to the purchase price in US Dollars required to join a team for paid-for leagues. For instance, whereby a league comprises ten users and each user pays ten US dollars to participate in the league, the first place user is paid 65.00 US Dollars, the second place user is paid $15.00 US Dollars, and the third place user is paid $10.00 US Dollars, and as an example the administrator of system 100 can earn $10.00 US Dollars as a transaction fee (e.g. 10% of the total $100.00 user purchase amount). Accordingly, whereby different number of users participate in a league, the breakdown of payouts can change. For example, a league with less than seven user participants can only pay the first ranked user a US Dollar reward and the transaction fee to the system 100 administrators in some instances.

In another aspect, ranking component 160 can be used in connection with assigning title ranks and regional ranks for users based on performance. For instance, the more a user competes in competition, the higher likelihood the user will be ranked. Users can be awarded in connection with rank such as receiving a title rank for winning, receiving a free entrance into the game, and other such rewards for competitive achievements.

Further, based on any of the above identified embodiments, the registration component 110, assignment component 120, drafting component 130, selling component 140, scoring component 150, and ranking component 160 can be employed by system 100 individually and in connection in non-limiting integrated manners. As an example, ten users register (e.g. via registration component 110) for a league at 10:15 am Eastern Standard Time on a Sunday. The users each pay $25.00 US Dollars to a respective user account to join a public game thereby the total contribution collectively by the users are $250.00. In an aspect, each user is assigned (e.g. via assignment component 120 in connection with registration component) a balance of 750 virtual dollars to purchase player units as per a predetermined rule established by the system administrator (e.g. technology owner). Other predetermined rules include the $25.00 US Dollar league entry fee, ten free transactions are allotted to each user, and transactions greater than ten cost each user a transaction fee of $00.15 US Dollars per transaction.

Furthermore, each user can purchase (e.g. drafting component) at least one player unit representing an athlete belonging to each of the following position quarterback, running back, wide receiver, tight end, defense and kicker to comprise the user portfolio. At 1:00 pm Eastern Standard Time on Sunday, the competition commences and each users portfolio lineup is locked. After 1:00 pm Eastern Standard Time, which is NFL kickoff time for numerous football games, the player units remain open for purchasing and selling from and to other users or the market. At the end of the day on Sunday night, after the football games for the day end, the daily market closes, and a score (e.g. via scoring component 150) is assigned to each user of the league. At the completion of the day the users are ranked based on the score (e.g. based on the highest portfolio value) and the top three ranked (e.g. using ranking component 160) users are paid $100.00, $75.00, and $50.00 US Dollars as winnings for the competition. The system administrator is paid a ten percent administration fee thus amounting to $25.00 US Dollars.

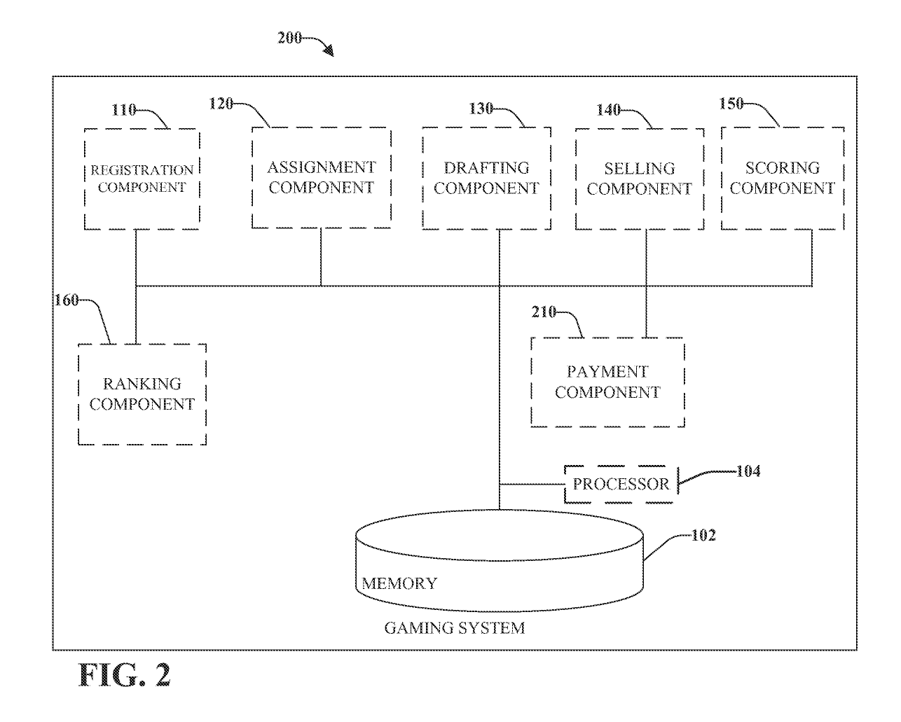

Turning now to FIG. 2, presented is another exemplary non-limiting embodiment of system 200 in accordance with the subject disclosure. In an aspect, system 200 that facilitates transferring funds from a user account to an administrator account. In an embodiment system 200 comprises system 100 employs a registration component 110, assignment component 120, drafting component 130, selling component 140, scoring component 150, ranking component 160, and payment component 210. In an aspect payment component 210 transfers funds from a user account to an administrator account.

A user register with a free league or a league that requires payment of a specified amount to join. A finalized transaction amount can take into consideration not only the entrance fee but also up front payments for future transactions, costs for add-on features, premium league payments, and other such additional fees. For instance, in an aspect, gaming system 100 can allow for buy-sell transactions of player units by each user, however, after X (e.g. whereby X is an integer) number of transactions a transaction cost can be required by the administrator to conduct more transactions. In another aspect, the finalized transaction amount can comprise any fees associated with premium features of gaming system 200 such as customizable player unit tickers with scrolling fair market values of various player units, forecasting data (e.g. forecasts of future player unit prices), expanded competition gameplay (e.g. regional competitions, local competitions, title games), hot or cold player unit lists, cheat sheets, ranking reports, game related weather condition reports, depth charts, and other additional premium features.

Further, in an aspect, payment component 210 can transfer funds such as US Dollars (e.g. in the amount specified by a finalized transaction amount or other specified amount) from a purchaser account to an administrator account. A purchaser account is an account for payment of fees associated with a user transaction or in connection with a user account. For instance, at the time of registration of the account, gaming system 100 can receive (e.g. via input component) user payment information such as credit card details, check routing numbers, e-commerce accounts, PayPal information, and other such payment details associated with the user. Payment component 210 can associate the user data and payment information with an individual purchaser account whereby transaction inflows (e.g. prize amounts for winning competitions, proceeds from prizes awarded during competition, etc.) and transaction outflows (e.g. payment of fees, transaction costs associated with purchase or sale of player units, purchase of add-ons, purchase of stickers, purchase of merchandise, etc.) can be debited or credited to the account in coordination with a transactional event. In an aspect, payment component 210 can transfer funds and receive funds at anytime before, during, and after a competition. The transfer of funds can be sent to or withdrawn from an administrator account, whereby such administrator account can be an account belonging to the proprietor of system 200, a merchant account (e.g. credit card company, bank, etc.), or any entity, individual or user charged with administering the system 200.

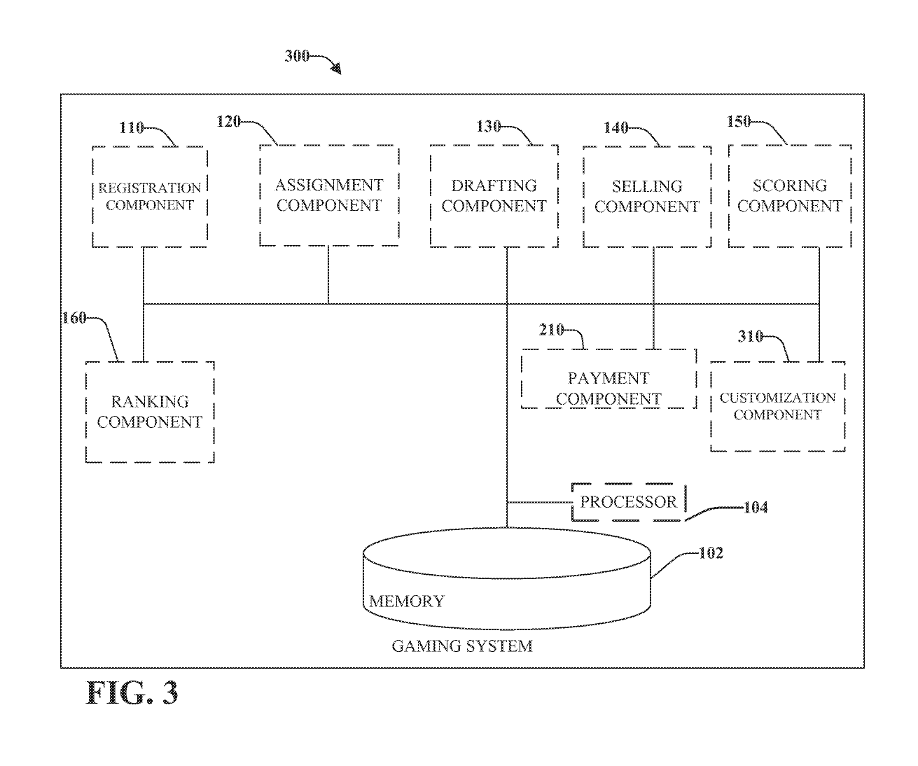

Turning now to FIG. 3, presented is another exemplary non-limiting embodiment of system 300 in accordance with the subject disclosure. In an aspect, system 200 that further comprise a customization component 310 that customizes a contest to include at least one of: a customizable player unit ticker, a sensitivity analysis calculator, a sortable player unit list. In an embodiment system 200 comprises system 100 employs a registration component 110, assignment component 120, drafting component 130, selling component 140, scoring component 150, ranking component 160, payment component 210, and customization component 310. In an aspect payment component 210 transfers funds from a user account to an administrator account. In an aspect, customization component 310 that customizes a contest to include at least one of: a customizable player unit ticker, a sensitivity analysis calculator, a sortable player unit list.

In an aspect, a user or administrator can customize the league to include additional features. In an aspect, customization component 310 can customize a contest, which is a competition within a league to allow a user to utilize a customizable player unit ticker. A user can customize a player unit ticker to comprise the respective player units belonging to the user portfolio or other player units of interest. The customizable ticker can transmit player unit price information, associated statistical data, or general news related to athletic competitions and athletes representative of the player units. In an aspect, if the ticker is not customized it can display the top five player units belonging to each respective position as a default setting. In another aspect, customization component 310 can customize a sensitivity analysis calculator to assist a user at forecasting present and future player unit prices. The sensitivity analysis, in an aspect, can forecast statistical measures of the performance of player units and correlate those measures to future performance of the player units.

In another aspect, customization component 310 can customize a contest to include player unit lists such as a hot and cold player unit list. In an aspect, the hot and cold list provides information as to the highest gaining player unit performers and lowest ranked player units. These lists can run throughout the competition and allow a user to sort and sift through the lists (e.g. gathered each quarter, half, or game). Additionally, in an aspect, the user can sort the list by fields such as position of player unit, name of player unit, pricing information.

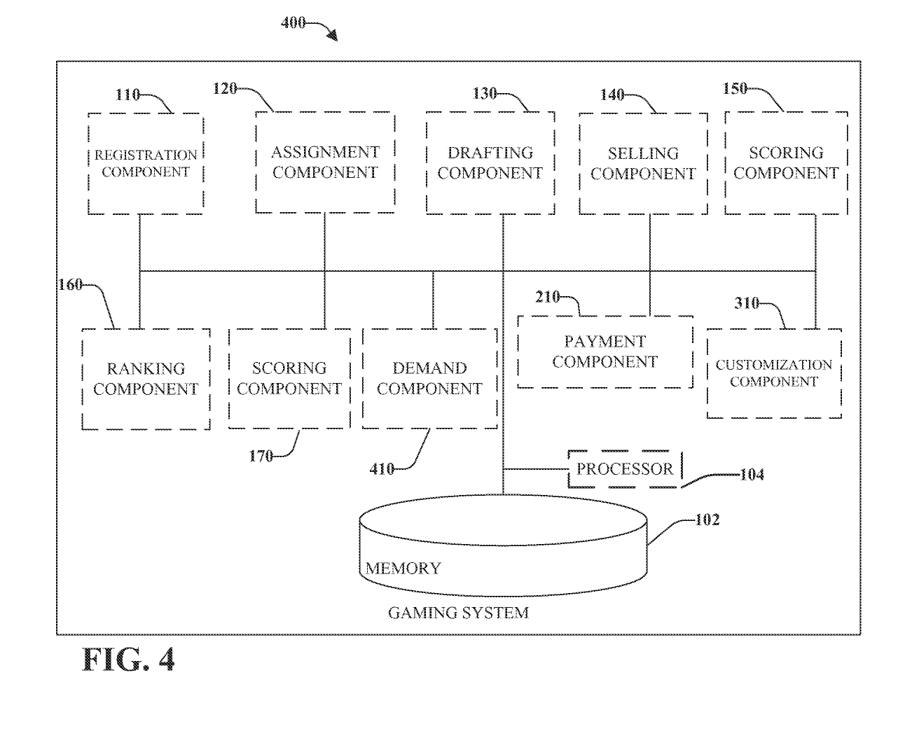

Turning now to FIG. 4, presented is another exemplary non-limiting embodiment of system 400 in accordance with the subject disclosure. In an aspect, system 400 further comprise a demand integration component that incorporates a demand for a player unit to value the player unit. System 400 includes a customization component 310 that customizes a contest to include at least one of: a customizable player unit ticker, a sensitivity analysis calculator, a sortable player unit list. In an embodiment system 200 comprises system 100 employs a registration component 110, assignment component 120, drafting component 130, selling component 140, scoring component 150, ranking component 160, payment component 210, customization component 310, and demand component 410.

In accordance with system 400, demand component 410 incorporates a demand for a player unit as a contributing factor to value the player unit. The demand functionality can be demonstrated by an example whereby, ten users register (e.g. via registration component 110) for a league at 10:15 am Eastern Standard Time on a Sunday. The users each pay $25.00 US Dollars to a respective user account to join a public game thereby the total contribution collectively by the users are $250.00. In an aspect, each user is assigned (e.g. via assignment component 120 in connection with registration component) a balance of 750 virtual dollars to purchase player units as per a predetermined rule established by the system administrator (e.g. technology owner). Other predetermined rules include the $25.00 US Dollar league entry fee, ten free transactions are allotted to each user, and transactions greater than ten cost each user a transaction fee of $00.15 US Dollars per transaction.

In an aspect, user A, user B, and user C each respectively desire to purchase the player unit representing the athlete Tom Brady. User A purchases the Tom Brady player unit for $100 virtual dollars. Subsequently user B purchases the Tom Brady player unit, but must pay $110 virtual dollars because the demand for Tom Brady player unit was high. User C does not purchase the Tom Brady player unit, thus the remaining virtual dollars are user A $650 ($750 starting virtual dollar balance-$650 to purchase the player unit), user B $640 ($750−$110 virtual dollars), and user C is $750. Tom Brady player unit now costs $121 virtual dollars due to the heightened demand from user A and user B. If user C purchases Tom Brady player unit then as a result of the increasing demand user A has gained $10 virtual dollars because user B and user C purchased the same player unit. Also user B has a $11 portfolio gain all before the competition has commenced. User C would not gain any portfolio value but has a remaining balance of $639 virtual dollars. This example illustrates that demand component 410 incorporates a demand for a player unit as a contributing factor to value the player unit.

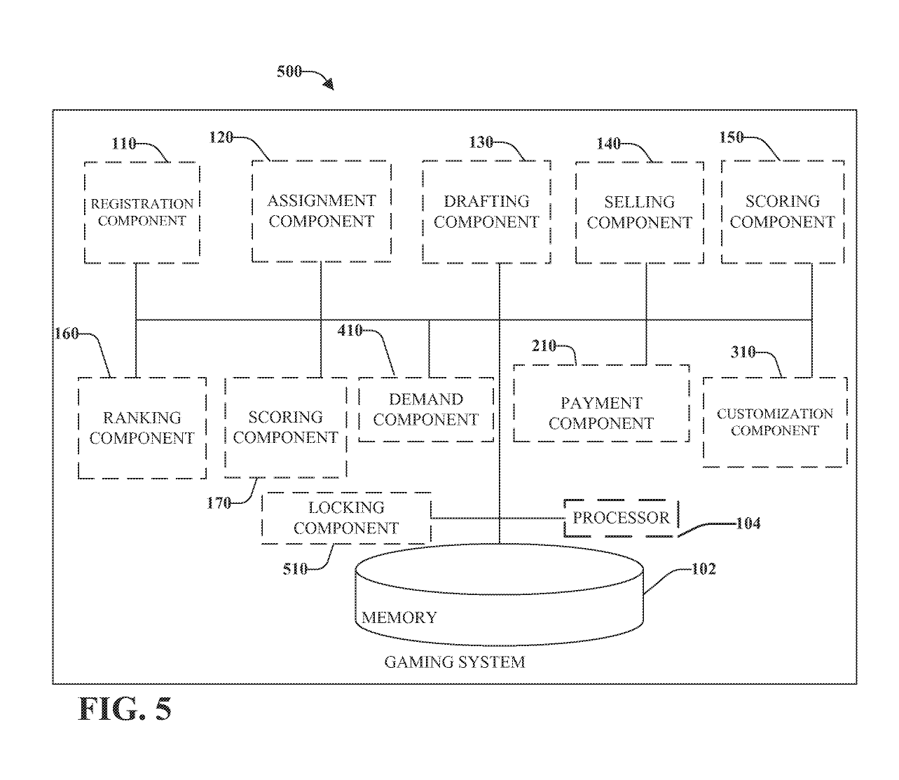

Turning now to FIG. 5, presented is another exemplary non-limiting embodiment of system 500 in accordance with the subject disclosure. In an aspect, system 500 further comprise a locking component that denies permission to the user to purchase player units based on the satisfaction of purchasing X number of player units added to the user portfolio and confirmed by the user. wherein X is an integer. System 500 includes a customization component 310 that customizes a contest to include at least one of: a customizable player unit ticker, a sensitivity analysis calculator, a sortable player unit list. In an embodiment system 200 comprises system 100 employs a registration component 110, assignment component 120, drafting component 130, selling component 140, scoring component 150, ranking component 160, payment component 210, customization component 310, demand component 410, and locking component 510. In an aspect, locking component 510 denies permission to the user to purchase player units based on the satisfaction of purchasing X number of player units added to the user portfolio and confirmed by the user, wherein X is an integer.

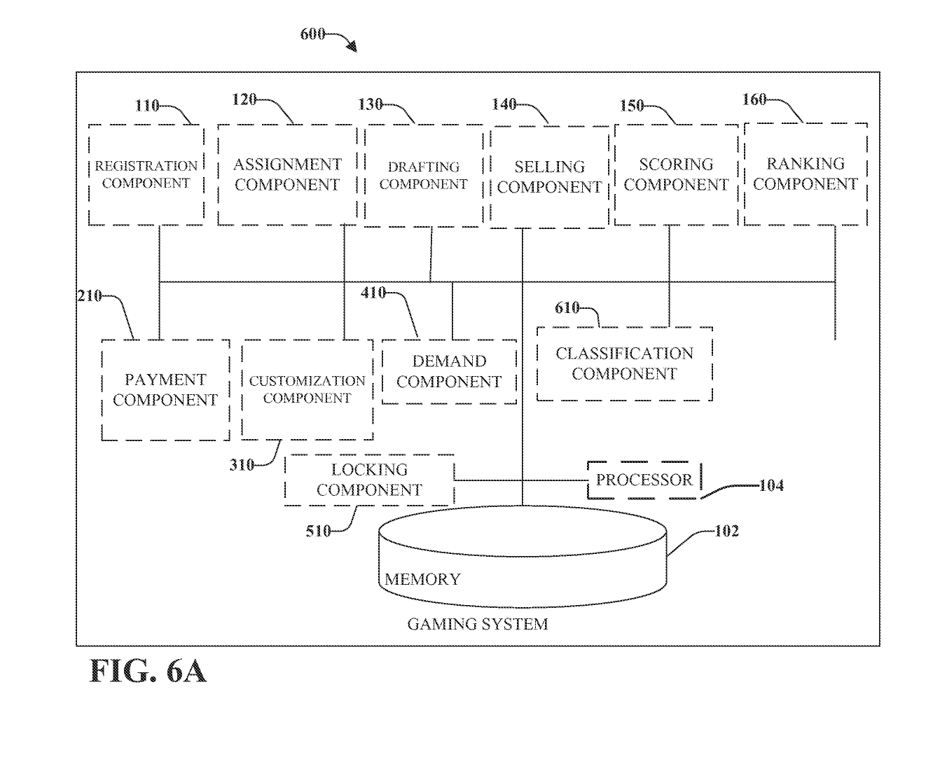

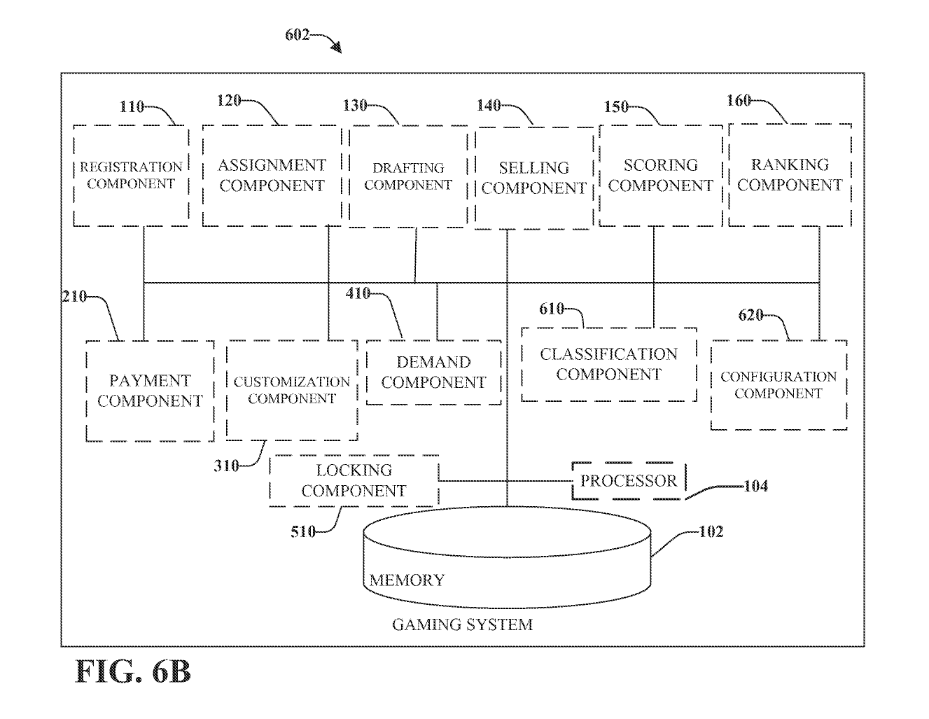

Turning now to FIG. 6A, presented is another exemplary non-limiting embodiment of system 600 in accordance with the subject disclosure. In an aspect, system 600 further comprise a classification component 610 that classifies the user data based at least on one of: the date, cost, time frame, sport genre, transaction amount limit, or virtual cash allotment. In an embodiment system 600 comprises a registration component 110, assignment component 120, drafting component 130, selling component 140, scoring component 150, ranking component 160, payment component 210, customization component 310, demand component 410, locking component 510, and classification component 610. In an aspect, classification component 610 classifies the user data based at least on one of: the date, cost, time frame, sport genre, transaction amount limit, or virtual cash allotment.

Turning now to FIG. 6B presented is another exemplary non-limiting embodiment of a display for system 602 in accordance with the subject disclosure. In an aspect, system 700 further comprise configuration component 620 that configures a contest in accordance with one or more rule established by a creator or administrator. In an embodiment system 700 comprises a registration component 110, assignment component 120, drafting component 130, selling component 140, scoring component 150, ranking component 160, payment component 210, customization component 310, demand component 410, locking component 510, and classification component 610, and configuration component 620. In an aspect, configuration component 620 that configures a contest in accordance with one or more rule established by a creator or administrator.

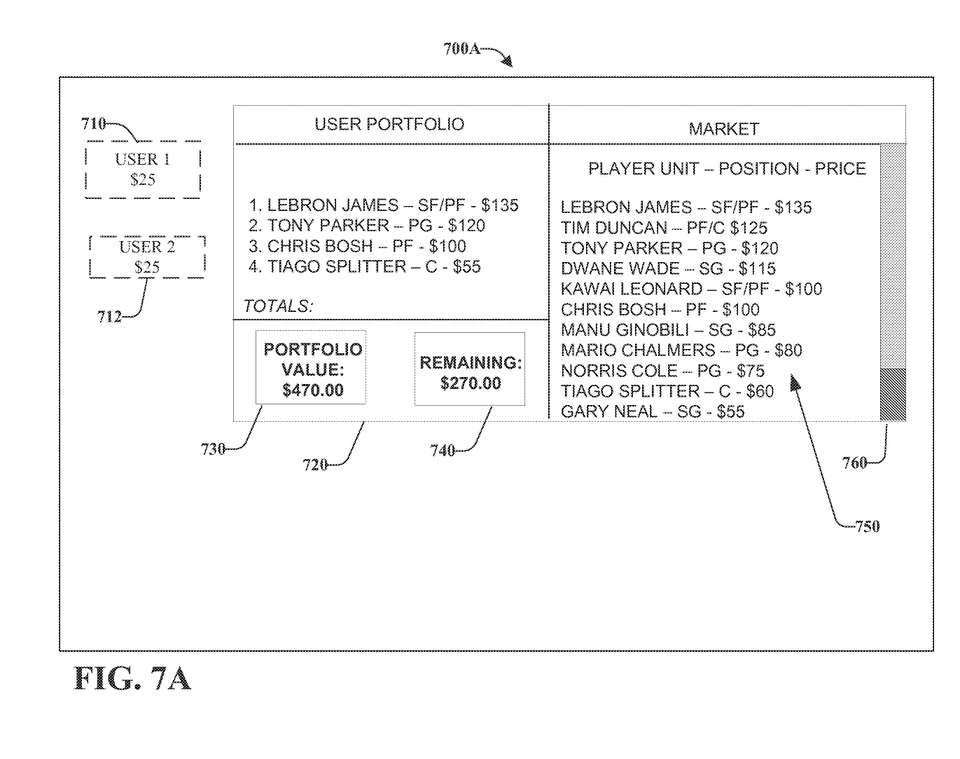

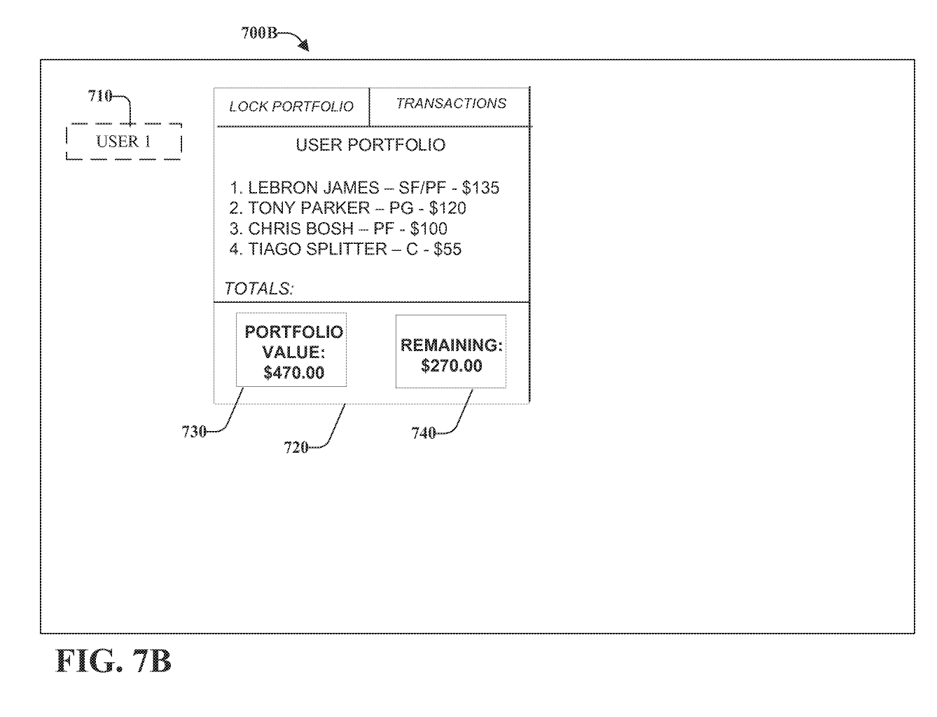

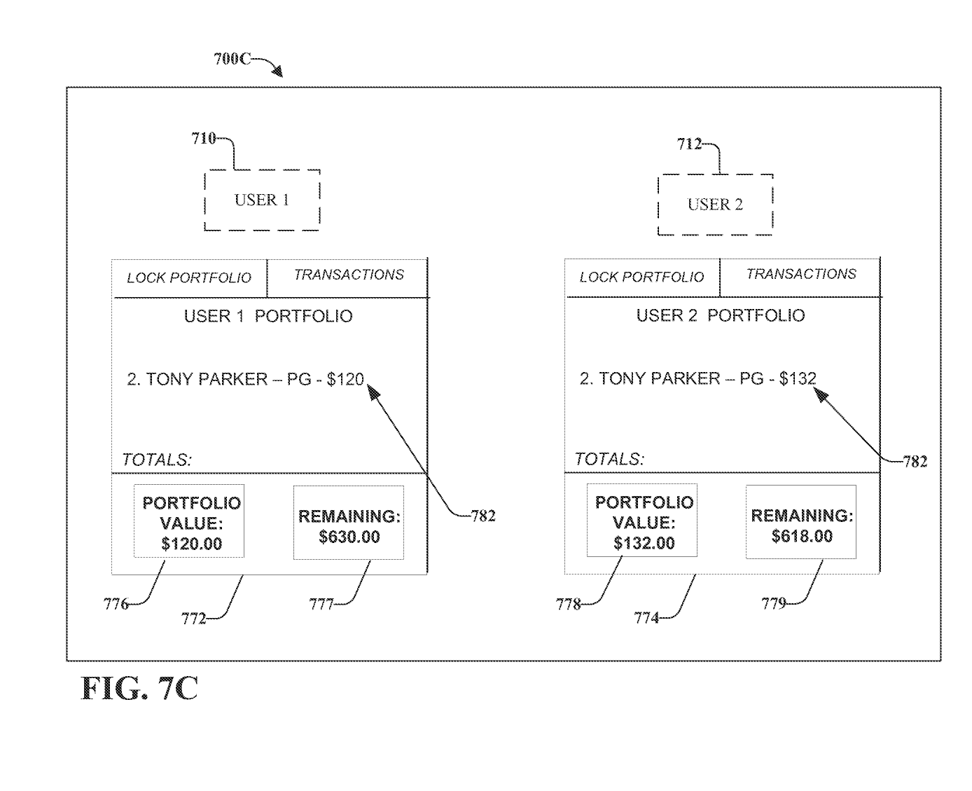

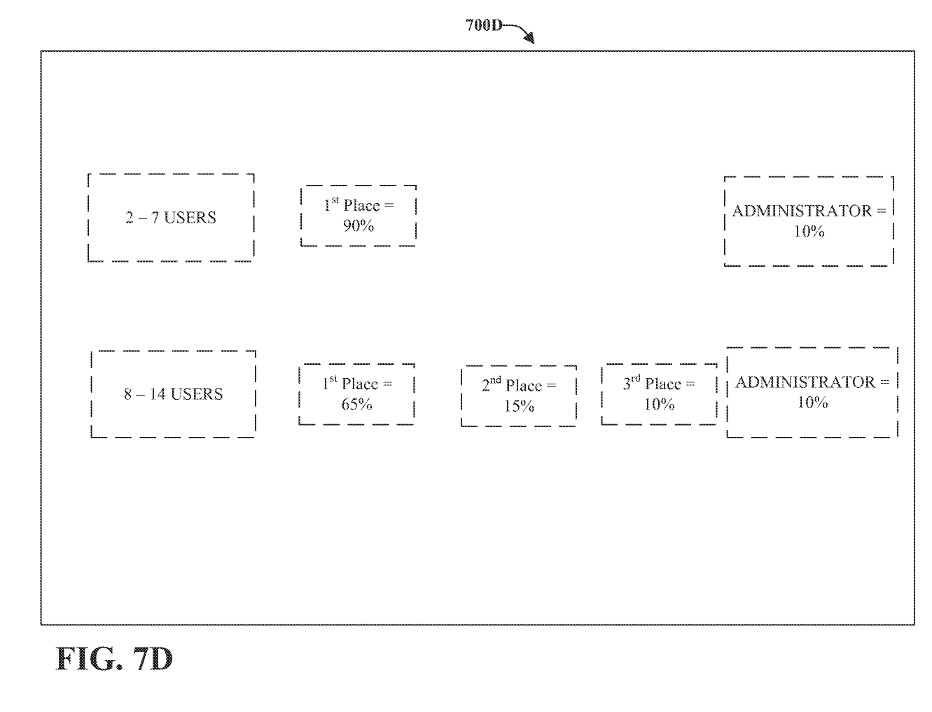

Turning now to FIG. 7A, presented is an illustration of an exemplary non-limiting embodiment of gameplay of system 700A, which demonstrates a non-limiting display of user drafting. At User A 710, a user A contributes $25 in real money to join a league and at User B 712, a user B contributes $25 in real money to join a league. Thus the total pot is $50 US Dollars. At display screen 720 the user selects player units for all available positions and once accomplished the user is notified to submit his portfolio for locking. At portfolio value 730, a portfolio value of the collective value of player units in the portfolio is illustrated as an amount of virtual currency units, which is $470 virtual dollars as demonstrated in the illustration. At remainder 740, the display demonstrates the remaining portfolio value in terms of virtual currency units available for use (e.g. to purchase more player units, incur transactions, etc.). At player screen 750, an illustration of the player units as a scrollable list is displayed. The user can click a player from the list and drag to the user portfolio to select the player for portfolio ownership. At scroll bar 760, a scrollable bar is demonstrated to facilitate the up and down scrolling option to view player units throughout the list. Thus one or more user can join a game by paying money or entering for free in a free league. Upon payment, the user can select player units using allotted virtual currency units. The player units value can be determine by a variety of valuation techniques including a proprietary algorithm, real time statistical input, and so on. The user can view the total value of all the player units and also the remaining virtual currency balance available for spending.

Turning now to FIG. 7B, presented is an illustration of an exemplary non-limiting embodiment of a display in connection with system 700B. Illustration 700B demonstrates the view of the user portfolio after the user has decided to lock the portfolio. After locking the portfolio, the user can make transactions in the navigation menu.

Turning now to FIG. 7C, presented is an illustration of an exemplary non-limiting embodiment of a display in connection with system 700C. Illustration 700C demonstrates the view of the user portfolio after the users have established portfolios and the competition has commenced. Each user can view one another's portfolio. It is demonstrated that User A purchased player unit representing Tony Parker for less than User B because User B purchased the player unit after User A and the value of Tony Parker player unit is set by the market which can incorporate demand. At value box 776 it is demonstrated that both user A and user B (illustrated at 778) have the same portfolio value but user A has a greater remaining balance (illustrated at 777) than user B remaining balance (illustrated at 779) because the price of the Tony Parker player unit for User B (illustrated at 782) was more than for User A (illustrated at 782). In general, users can buy or sell any player unit to and from the market at any moment provided the player unit is actively trading (e.g. playing) and the user does not currently own the player unit. In an aspect, if a user gains or loses on a player unit sold, then the price will be reflected in the users portfolio value and remaining balance.

Turning now to FIG. 7D, presented is an illustration of an exemplary non-limiting embodiment of a display in connection with illustration 700D. Throughout the time frame of the competition, users compete against one another via portfolio value. Upon completion of the competition, the user with the highest portfolio value in some instances is paid out. At illustration 700D the payouts are demonstrated for a few non-limiting scenarios.

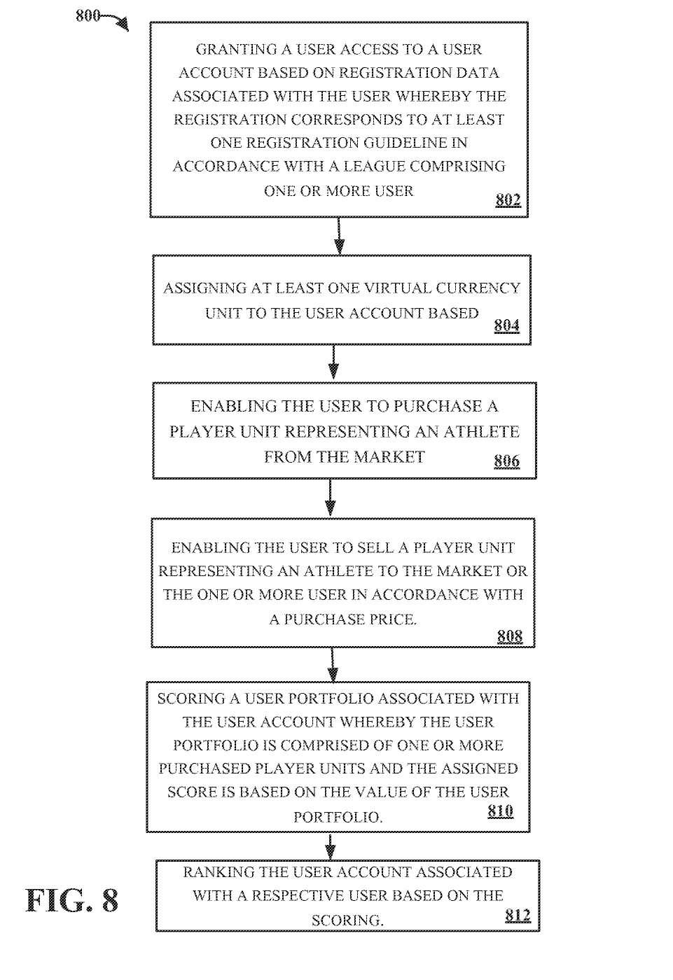

FIG. 8 illustrates a methodology or flow diagram in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices.

Referring now to FIG. 8, presented is a flow diagram of an example application of methodology 800 described herein. In an aspect, exemplary methodology 800 of a trading system is stored in a memory and utilizes a processor to execute computer executable instructions to perform functions. At 802, is the granting a user access to a user account based on registration data associated with the user whereby the registration data corresponds to at least one registration guideline in accordance with a league comprising one or more user. At 804, is the assigning at least one virtual currency unit to the user account based on a predefined rule or the at least one registration guideline. At 806, is enabling the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price;

At 808, is enabling the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price. At 810, is scoring a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account. At 812 is ranking the user account associated with a respective user based on the scoring.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described in this disclosure. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

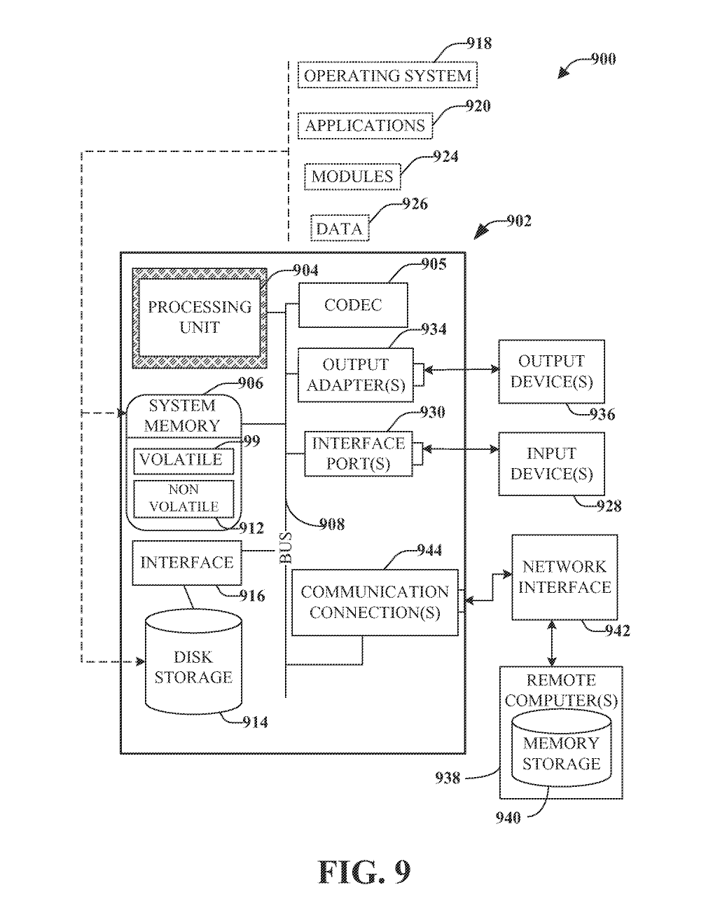

With reference to FIG. 9, a suitable environment 900 for implementing various aspects of the claimed subject matter includes a computer 902. The computer 902 includes a processing unit 904, a system memory 906, a codec 905, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 906 includes volatile memory 910 and non-volatile memory 912. The basic input/output system (BIOS), containing the basic routines to transfer information between elements within the computer 902, such as during start-up, is stored in non-volatile memory 912. In addition, according to present innovations, codec 905 may include at least one of an encoder or decoder, wherein the at least one of an encoder or decoder may consist of hardware, combination of hardware and software, or software. Although, codec 905 is depicted as a separate component, codec 905 may be contained within non-volatile memory 912. By way of illustration, and not limitation, non-volatile memory 912 can include read only memory (ROM), programmable ROM (PROM), electrically programmable ROM (EPROM), electrically erasable programmable ROM (EEPROM), or flash memory. Volatile memory 910 includes random access memory (RAM), which acts as external cache memory. According to present aspects, the volatile memory may store the write operation retry logic (not shown in FIG. 9) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 902 may also include removable/non-removable, volatile/non-volatile computer storage medium. FIG. 9 illustrates, for example, disk storage 914. Disk storage 914 includes, but is not limited to, devices like a magnetic disk drive, solid state disk (SSD) floppy disk drive, tape drive, Jaz drive, Zip drive, LS-70 drive, flash memory card, or memory stick. In addition, disk storage 914 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 914 to the system bus 908, a removable or non-removable interface is typically used, such as interface 916.

It is to be appreciated that FIG. 9 describes software that acts as an intermediary between users and the basic computer resources described in the suitable operating environment 900. Such software includes an operating system 918. Operating system 918, which can be stored on disk storage 914, acts to control and allocate resources of the computer system 902. Applications 920 take advantage of the management of resources by operating system 718 through program modules 924, and program data 926, such as the boot/shutdown transaction table and the like, stored either in system memory 906 or on disk storage 914. It is to be appreciated that the claimed subject matter can be implemented with various operating systems or combinations of operating systems.

A user enters commands or information into the computer 902 through input device(s) 928. Input devices 928 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 904 through the system bus 908 via interface port(s) 930. Interface port(s) 930 include, for example, a serial port, a parallel port, a game port, and a universal serial bus (USB). Output device(s) 936 use some of the same type of ports as input device(s) 928. Thus, for example, a USB port may be used to provide input to computer 902, and to output information from computer 902 to an output device 936. Output adapter 934 is provided to illustrate that there are some output devices 936 like monitors, speakers, and printers, among other output devices 936, which require special adapters. The output adapters 934 include, by way of illustration and not limitation, video and sound cards that provide a means of connection between the output device 936 and the system bus 908. It should be noted that other devices and/or systems of devices provide both input and output capabilities such as remote computer(s) 938.

Computer 902 can operate in a networked environment using logical connections to one or more remote computers, such as remote computer(s) 938. The remote computer(s) 938 can be a personal computer, a server, a router, a network PC, a workstation, a microprocessor based appliance, a peer device, a smart phone, a tablet, or other network node, and typically includes many of the elements described relative to computer 902. For purposes of brevity, only a memory storage device 940 is illustrated with remote computer(s) 938. Remote computer(s) 938 is logically connected to computer 902 through a network interface 942 and then connected via communication connection(s) 944. Network interface 942 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 944 refers to the hardware/software employed to connect the network interface 942 to the bus 908. While communication connection 944 is shown for illustrative clarity inside computer 902, it can also be external to computer 902. The hardware/software necessary for connection to the network interface 942 includes, for exemplary purposes only, internal and external technologies such as, modems including regular telephone grade modems, cable modems and DSL modems, ISDN adapters, and wired and wireless Ethernet cards, hubs, and routers.

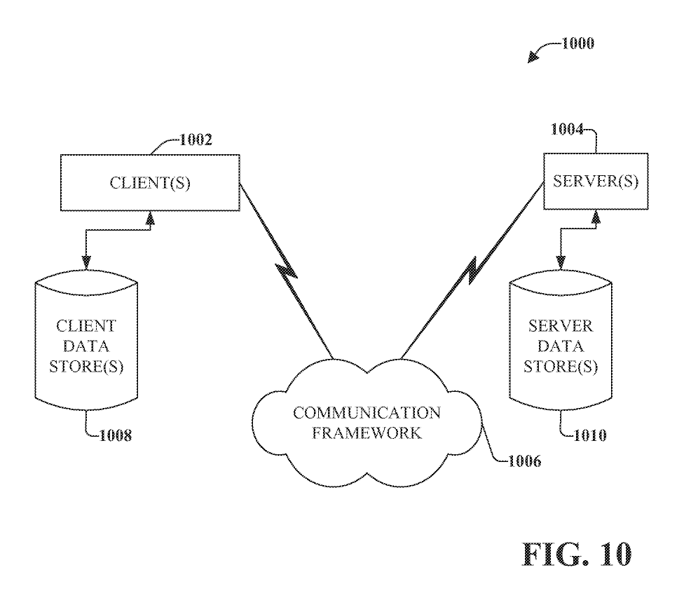

Referring now to FIG. 10, there is illustrated a schematic block diagram of a computing environment 1000 in accordance with this disclosure. The system 1000 includes one or more client(s) 1002 (e.g., laptops, smart phones, PDAs, media players, computers, portable electronic devices, tablets, and the like). The client(s) 1002 can be hardware and/or software (e.g., threads, processes, computing devices). The system 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. One possible communication between a client 1002 and a server 1004 can be in the form of a data packet transmitted between two or more computer processes wherein the data packet may include video data. The data packet can include metadata, e.g., associated contextual information, for example. The system 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 include or are operatively connected to one or more client data store(s) 1008 that can be employed to store information local to the client(s) 1002 (e.g., associated contextual information). Similarly, the server(s) 1004 are operatively include or are operatively connected to one or more server data store(s) 1010 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated, that a client 1002 can also transfer uncompressed file to a server 1004 and server 1004 can compress the file in accordance with the disclosed subject matter. Likewise, server 1004 can encode video information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system comprising:
a memory having stored thereon computer executable components; and
a processor, communicatively coupled to the memory, that executes or facilitates execution of one or more computer-executable components, the computer-executable components, comprising:
a registration component that grants a user access to a user account based on registration data associated with the user whereby the registration data corresponds to at least one registration guideline in accordance with a league comprising one or more user;
an assignment component that assigns at least one virtual currency unit to the user account based on a predefined rule or the at least one registration guideline;
a drafting component that enables the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price;
a selling component that enables the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price;
a scoring component that assigns a score to a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account; and
a ranking component that ranks the user account associated with a respective user based on the scoring.

2. The system of claim 1, further comprising payment component that transfers funds from a user account to an administrator account.

3. The system of claim 1, further comprising a customization component that customizes a contest to include at least one of: a customizable player unit ticker, a sensitivity analysis calculator, a sortable player unit list.

4. The system of claim 1, further comprising a demand component that incorporates a demand for a player unit to value the player unit.

5. The system of claim 1, further comprising a locking component that denies permission to the user to purchase player units based on the satisfaction of purchasing X number of player units added to the user portfolio and confirmed by the user, wherein X is an integer.

6. The system of claim 1, further comprising a classification component that classifies the user data based at least on one of: the date, cost, time frame, sport genre, transaction amount limit, or virtual cash allotment.

7. The system of claim 1, further comprising configuration component that configures a contest in accordance with one or more rule established by a creator or administrator.

8. The system of claim 7, wherein the one or more rule is at least one of: a predetermined virtual currency balance amount, salary cap limit, allotment of free transaction, or total transaction limit.

9. The system of claim 1, wherein the registration guidelines can be at least one of: the date, cost, time frame, sport genre, transaction amount limit, or virtual cash allotment.

10. The system of claim 1, whereby the user portfolio comprises a player unit of one or more mandatory position corresponding to a respective sport genre.

11. The method, comprising:
using a processor to execute the following computer executable instructions stored in a memory to perform the following acts:
granting a user access to a user account based on registration data associated with the user whereby the registration data corresponds to at least one registration guideline in accordance with a league comprising one or more user;
assigning at least one virtual currency unit to the user account based on a predefined rule or the at least one registration guideline;
enabling the user to purchase a player unit representing an athlete from the market or the one or more user in accordance with a purchase price that represents a quantity of the at least one virtual currency unit whereby the purchase price is based on at least one of: a market rate, a bid price, a demand price, athlete statistical performance or a custom price;
enabling the user to sell a player unit representing an athlete to the market or the one or more user in accordance with a sale price that represents a quantity of the at least one virtual currency unit whereby the purchase price is based on at least one of: a market rate, an ask price, athlete statistical performance or a custom price;
a scoring component that assigns a score to a user portfolio associated with the user account whereby the user portfolio is comprised of one or more purchased player units and the assigned score is based on the value of the user portfolio as a function of at least one of: a total portfolio value, a total portfolio gain, a total percentage gain, a total portfolio loss, or a total percentage loss corresponding to a respective user account; and
a ranking component that ranks the user account associated with a respective user based on the scoring.

12. The method of claim 11, further comprising transferring funds from a user account to an administrator account.

13. The method of claim 11, further comprising customizing a contest to include at least one of: a customizable player unit ticker, a sensitivity analysis calculator, a sortable player unit list.

14. The method of claim 11, further comprising incorporating a demand for a player unit to value the player unit.

15. The method of claim 11, further comprising denying permission to the user to purchase player units based on the satisfaction of purchasing X number of player units added to the user portfolio and confirmed by the user, wherein X is an integer.

16. The method of claim 11, further comprising classifying the user data based at least on one of: the date, cost, time frame, sport genre, transaction amount limit, or virtual cash allotment.

17. The method of claim 11, comprising configuring a contest in accordance with one or more rule established by a creator or administrator.

18. The method of claim 17, wherein the predetermined rule is at least one of: a predetermined virtual currency balance amount, salary cap limit, allotment of free transaction, or total transaction limit.

19. The method of claim 11, wherein the registration guidelines can be at least one of: the date, cost, time frame, sport genre, transaction amount limit, or virtual cash allotment.

20. The method of claim 11, whereby the user portfolio comprises a player unit of one or more mandatory position corresponding to a respective sport genre.
